(19) United States
(12) Patent Application Publication
(10) Pub. No.: US 2015/0373385 A1
(43) Pub. Date: Dec. 24, 2015

(54) METHOD FOR PROVIDING TARGETED CONTENT IN IMAGE FRAMES OF A VIDEO AND CORRESPONDING DEVICE

(71) Applicant: THOMSON LICENSING, Issy-Ies- Moulineaux (FR)

(72) Inventors: Gilles STRAUB, Acigne (FR); Nicolas LE SCOUARNEC, Liffre (FR); Christoph NEUMANN, Rennes (FR); Stephane ONNO, Saint Gregoire (FR)

(21) Appl. No.: 14/766,120

(22) PCT Filed: Feb. 5, 2014
(86) PCT No.: PCT/EP2014/052187

§ 371 Date: Aug. 5, 2015

(30) Foreign Application Priority Data
Feb. 7, 2013 (EP) 13305151.6

(51) Int. Cl. H04N 21/2668; H04N 21/858; H04N 21/81; H04N 21/234; H04N 21/258

(52) U.S. Cl. CPC H04N 21/2668; H04N 21/23424; H04N 21/25891; H04N 21/812; H04N 21/8586

(57) ABSTRACT

Method for providing targeted content in image frames of a video and corresponding device A scalable and flexible solution for targeting a video through overlaying image frame zones with content that is targeted to individual users according to user preferences is provided. A video sequence is processed to determine sequences of image frames that comprise overlayable zones for overlay with targeted content. Features that describe these frames and these zones for a content overlay operation are stored in metadata that is associated to the unmodified video sequence. When the video is transmitted to a user, the metadata is used to overlay content in the overlayable zones, whereby the content is chosen according to the preferences of the user.

### 1. FIELD OF INVENTION

The present invention relates to the field of overlay of targeted content into a video sequence, for example for targeted advertisement.

### 2. TECHNICAL BACKGROUND

Targeting of audio/video content in videos watched by users allows a content provider to create extra revenues, and allows users to be served with augmented content that is adapted to their personal taste. For the content provider, the extra revenues are generated from customers whose actions are influenced by the targeted content. Targeted content exists in multiple forms, such as advertisement breaks that are inserted in between video content. Document US2012/0047542A1 to Lewis et al. describes providing a dynamic manifest file that contains URLs that are adapted to the user preference, in order to insert in between the video content, appropriate advertising content estimated to be most relevant and interesting for a user. Advertisement content is targeted and prepared according to user tracking profile, adding appropriate pre-roll, mid-roll or post-roll advertising content estimated to be most relevant and interesting for the user. Document US2012/0137015A1 to Sun is of similar endeavor. When a content delivery system receives at request for a content stream, a play list is used that includes an ordered list of media segments files representing the content stream, and splice point tags that represent splice points in the media stream for inserting advertisement segments. An insertion position is identified in the playlist based on the splice point tags, an advertisement segment is selected that is inserted in the position of one of the splice points, and the modified playlist is transmitted to the video display device. However, with the advent of DVR's or PVR's (Digital Video Recorders/Personal Video Recorders), replay and on-demand TV and time shift functions, users have access to trick mode commands such as fast forward, allowing them to skip the advertisement breaks that are inserted in between the video content. For the content provider, skipped advertisements represent loss of revenue. Therefore, other technical solutions have been developed, such as overlaying advertisements in image frames of a video. Document WO02/37828A2 to McAlister describes overlaying targeted advertisement content in video frames while streaming the video to a user. A kind of ‘green screening’ or ‘chroma key’ method is used, which needs specific preparation of the video, by providing an ad screening area in the scene prior to filming, the ad screening area having a characteristic that allows the area to be distinguished from other components in the scene. When the video is streamed to a user, the ad screening areas are identified in video frames based on the distinguishing characteristic of the ad screening area, and the image of the ad screening area is replaced by an ad image that is selected based on demographic data. Ad screening areas that are not occupied by an advertisement are replaced by a filler. However, this prior art technique has the disadvantage that the ad screening areas must be prepared in a filmable scene, in order to create the ad screening areas in the video. This makes the technique difficult or even impossible to apply to existing video content that has not been filmed and prepared to include ad screening areas. In scenes that contain ad screening areas that are not used, the ad screening areas are replaced with fillers, resulting in a loss of usable area in these scenes, that could have been used during filming. Further, to know the ad screening areas in the video a video processing of the video in order to recognize the ad screening areas in the video frames, and video processing is known to be a computing power intensive task. The prior art solutions for targeting advertisements in video content to users are thus easy to circumvent or lack flexibility.

There is thus a need for an optimized solution that solves some of the problems related to the prior art solutions.

### 3. SUMMARY OF THE INVENTION

The purpose of this invention is to solve at least some of the problems of prior art discussed in the technical background section by means of a method and device of providing targeted content in image frames of a video.

The current invention comprises a method of providing targeted content in image frames of a video, implemented in a server device, the method comprising determining sequences of image frames in the video comprising image zones for overlaying with targeted content, and associating metadata to the video, the metadata comprising features describing the determined sequences of image frames and the image zones; receiving, from a user, a request for transmission of the video; overlaying, in the video, image zones of sequences of image frames that are described by the metadata, with content that is targeted according to the associated metadata and according to user preference of the user; and transmission of the video to the user.

According to a variant embodiment of the method, the overlaying comprises dynamic adaptation of the targeted content to changing graphical features of the image zones in the sequences of image frames.

According to a variant embodiment of the method, the determining comprises detecting sequences of image frames that comprise image zones that are graphically stable.

According to a variant embodiment of the method, the graphical features comprise a geometrical distortion of the image zones.

According to a variant embodiment of the method, the graphical features comprise a luminosity of the image zones.

According to a variant embodiment of the method, the graphical features comprise a colorimetric of the image zones.

According to a variant embodiment of the method the features comprise a description of a scene to which the sequences of image frames belongs.

According to a variant embodiment of the method, it further comprises a step of re-encoding the video so that each of the determined sequences of image frames in the video starts with a Group of Pictures.

According to a variant embodiment of the method, it further comprises a step of re-encoding the video so that each of the determined sequences of image frames is encoded using a closed Group of Pictures.

According to a variant embodiment of the method, the determined sequences of image frames are encoded using a lower compression rate than other sequences of image frames of the video.

According to a variant embodiment of the method, the metadata comprises Uniform Resource Locators for referring to the determined sequences of image frames in the video.

The invention further relates to a server device for providing targetable content in images of a requested video sequence, the device comprising.

The invention further relates to a receiver device for receiving targeted content in image frames of a video, the device comprising a determinator, for determining sequences of image frames in the video comprising image zones for overlaying with targeted content, and for associating metadata to the video, the metadata comprising features describing the determined sequences of image frames and the image zones; a network interface for receiving a user request for transmission of the video; a content overlayer, for overlaying, in the video, image zones of sequences of image frames that are described by the metadata, with content that is targeted according to the associated metadata and according to user preference of the user; and a network interface for transmission of the video to the user.

The discussed advantages and other advantages not mentioned in this document will become clear upon the reading of the detailed description of the invention that follows.

### 4. LIST OF FIGURES

More advantages of the invention will appear through the description of particular, non-restricting embodiments of the invention. The embodiments will be described with reference to the following figures:

FIG. 1 illustrates content overlaying in an image frame of a video sequence according to the invention.

FIG. 2 illustrates a variant embodiment of the method of the invention.

FIG. 3 is an example of data that comes into play when providing targetable content in image frames of a video sequence according to the invention.

FIG. 4 is an architecture for a delivery platform according to a particular embodiment of the invention.

FIG. 5 is a flow chart of a particular embodiment of the method of providing targetable content in image frames of a video sequence according to the invention.

FIG. 6 is an example embodiment of a server device for providing targetable content in image frames of a requested video sequence according to the invention.

FIG. 7 is an example embodiment of a receiver device according to the invention.

### 5. DETAILED DESCRIPTION OF THE INVENTION

In the following, a distinction is made between “generic” image frame sequences of a video, “targetable” image frame sequences, and “targeted” image frame sequences. An “image frame sequence” is a sequence of image frames of a video. A “generic” image frame sequence is an image frame sequence that is destined to many users without distinction, i.e. it is the same for all users. A “targetable” image frame sequence is a frame sequence that can be targeted, or personalized, for a single user according to user preferences. According to the invention, this targeting or personalizing is carried out by overlaying targeted content (i.e. content that specifically targets a single user) in image frames that are comprised in the targetable video frame sequence. Once the overlaying operation has been carried out, the targetable video frame sequence is said to have become a “targeted” or “personalized” frame sequence.

In the following, the term ‘video’ means a sequence of image frames, that, when played one after the other, makes a video. Example of a video is (an image frame sequence of) a movie, a broadcast program, a streamed video, or a Video on Demand. A video may comprise audio, such as for example the audio track(s) that relate to and that are synchronized with the image frames of the video track.

In the following, term ‘overlay’ is used in the context of overlaying content in video. Overlaying means that one or more image frames of a video are modified by incrustation inside the one or more image frames of the video of one or several texts, images, or videos, or any combination of these. Examples of content that can be used for overlaying are: text (e.g. that is overlayed on a plain surface appearing in one or more image frames of the video); a still image (overlayed on a billboard in one or more image frames of the video); or even video content that comprising an advertisement (e.g. overlayed in a billboard that is present in a sequence of image frames in the video). Overlay is to distinguish from insertion. Insertion is characterized by inserting image frames into a video, for example, inserting image frames related to a commercial break, without modifying the visual content of the image frames of the video. Traditionally, overlaying content in a video is much more demanding in terms of required computing resources than mere image frame insertion. In many cases, overlaying content even requires human intervention. It is one of the objectives of the current invention to propose a solution for providing targeted content in a video where human intervention is reduced to the minimum, or even not needed at all. Among others, the invention therefore proposes a first step, in which image zones in sequences of video frames in a video are determined for receiving targeted content, and where metadata is created that will serve during a second step, in which targeted content is chosen and overlayed in image zones of the determined image sequences. Human intervention, if required at all, is reduced to the first step, whereas the video can be targeted later on, needed e.g. while streaming the video to a user or to a group of users, for example according to user preferences. The solution of the invention advantageously allows optimization of the workflow for overlaying targeted content in image frames of a video. The method of the invention has a further advantage to be flexible, as it does not impose specific requirement to the video (for example, during filming), and the video remains unaltered in the first step.

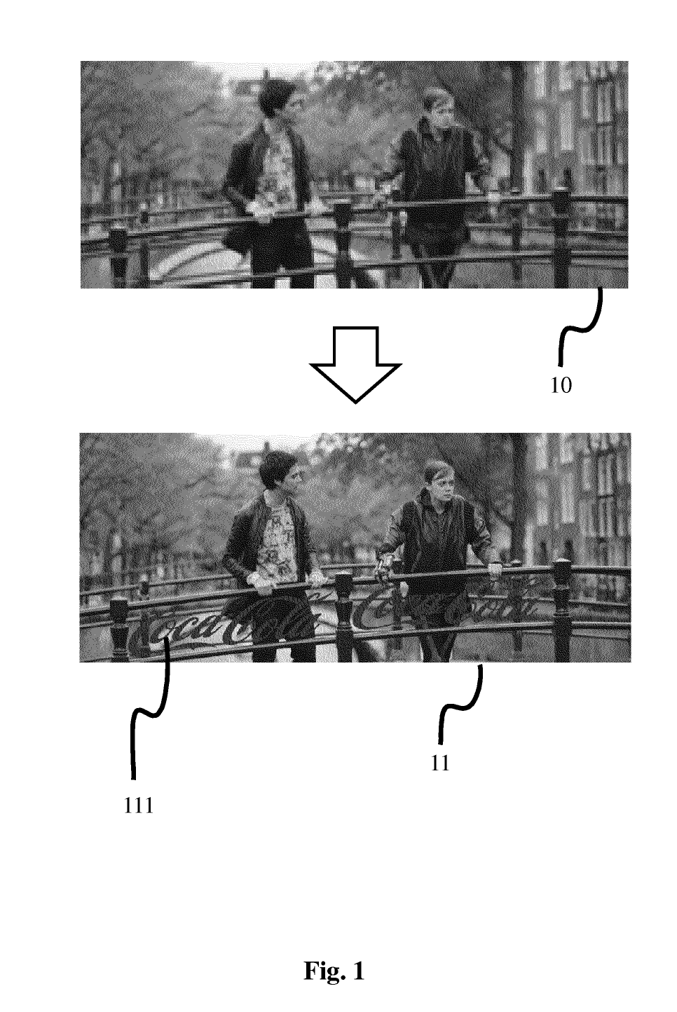

FIG. 1 illustrates an image of a video wherein content is overlayed according to the invention. Image frame 10 represents an original image frame. Image frame 11 represents a targeted image frame. Element 111 represents an image frame that is overlayed in image 11.

The method of the invention comprises association of metadata to the video that is for example prepared during an “offline” preparation step; though this step can be implemented as an online step if sufficient computing power is available. The metadata comprises information that is required to carry out overlay operations in the video to which it is associated. For the generation of the metadata, image frame sequences are determined that are suitable for content overlay, e.g. image frame sequences that comprise a graphically stable image zone. For each determined image frame sequence, metadata is generated that is required for a content overlay operation. This metadata comprises for example the image frame numbers of the determined image frame sequence, and for each image frame in the determined image frame sequence, coordinates of the image zone inside the image that can be used for overlay (further referred to as ‘overlay zone’), geometrical distortion of the overlay zone, color map used, and luminosity. The metadata can also provide information that is used for selection of appropriate content to overlay in a given image frame sequence. This comprises information about the content itself (person X talking to person Y), the context of the scene (lieu, time period, . . . ), the distance of a virtual camera. The preparation step results in the generation of metadata that is related to content overlay in the video for the selection of appropriate content to overlay and for the overlay process itself. During transmission of the content to a user or to a group of users, this metadata is used to select appropriate overlayable content to be used for overlaying in a particular sequence of image frames. User preferences are used to choose advertisements that are particularly interesting for a user or for a group of users. The metadata thus comprises the features that describe the determined sequences of image frames and the overlay zones, and can be used to adapt selected content to a particular sequence of image frames, for example, by adapting the coordinates, dimensions, geometrical distortion and colorimetric, contrast and luminosity of the selected content to the coordinates, dimensions, geometrical distortion, colorimetric, contrast and luminosity of the overlay zone. This adaptation can be done on a frame-per-frame basis if needed, for example, if the features of the overlay zone change significantly during the image frame sequence. In this way, the targeted content can be dynamically adapted to the changing graphical features of the overlay zone in a sequence of image frames. For a user watching the overlayed image frames, it is as if the overlayed content is part of the original video.

According to a variant embodiment, parts of the video are re-encoded in such a manner that each of the determined sequence of image frames starts with a GOP (Group Of Pictures). For example, generic frame sequences are (re-)encoded with an encoding format that is optimized for transport over a network using a high compression rate, whereas the determined sequences of image frames are re-encoded in an intermediate or mezzanine format, that allows decoding, content overlay, and re-encoding without quality loss. The lower compression rate for the mezzanine format allows the editing operations required for the overlaying without degrading the image quality. However, a drawback of a lower compression rate is that it results in higher transport bit rate as the mezzanine format comprises more data for a same video sequence duration than the generic frame sequences. A preferred mezzanine format based on the widely used H.264 video encoding format is discussed by different manufacturers that are regrouped in the EMA (Entertainment Merchants Association). One of the characteristics of the mezzanine format is that it principally uses a closed GOP format which eases image frame editing and smooth playback. Preferably, both generic and targetable frame sequences are encoded such that a video frame sequence starts with a GOP (i.e. starting with an I-frame) when Inter/intra compression is used, so as to ensure that a decoder can decode the first picture of each frame sequence.

The metadata and, according to the variant embodiment used, the (re-) encoded video, are stored for later use. The metadata can be stored, e.g. as a file, or in a data base.

The chosen content can be overlayed in the video during transmission of the video to the user device. This can be done when streaming without interaction of the user device, or by the use of a manifest file as described hereunder.

Using a manifest file, when a user device requests a video, a “play list” or “manifest” of generic and targetable image frame sequences is generated and then transmitted to the user. The play list comprises information that identifies the different image frame sequences and a server location from which the image frame sequences can be obtained, for example as a list of URLs (Uniform Resource Locators). According to a particular embodiment of the invention, these URLs are self-contained, and a URL uniquely identifies an image frame sequence and comprises all information that is required to fetch a particular image frame sequence; for example, the self-contained URL comprises a unique targetable image frame sequence identifier, and a unique overlayable content identifier. This particular embodiment is advantageous for the scalability of the system because it allows separating the various components of the system and scaling them as needed. According to a variant embodiment, the URLs are not self-contained but rather comprise identifiers that refer to entries in a data base that stores all information needed to fetch a determined image frame sequence. During the step of play list generation, it is determined, using the associated metadata and the user profile, which content is to be overlayed in which image frame sequence, and this information is encoded in the URLs. User profile information is for example collected from data such as buying behavior, Internet surfing habits, or other consumer behavior. This user profile is used to choose content for overlay that match with the user preference, for example, advertisements that are related to his buying behavior, or advertisements that are related to shops in his immediate neighborhood, or announcements for events such as theatre or cinema in his neighborhood that corresponds to his personal taste, and that match with the targetable video frame sequence (for example, an advertisement for a particular brand of drink, consisting of graphics being of a particular color, would not be suited to be overlayed in image frames that have the same or similar particular color).

For the image frame sequences that are ‘generic’, these image frame sequences can be provided without further computing by a content server, however according to a variant some computing may be required in order to adapt the frame sequence for transport over the network that interconnects the user device and the server or to monitor the video consumption of users. For the image frame sequences that are targetable, content is overlayed using the previously discussed metadata. According to a particular embodiment of the present invention, this overlay operation can be done by a video server that has sufficient computational resources to do a just-in-time (JIT) insertion i.e., the just-in-time computing meaning that the targeted content is computed just before the moment when targeted content is needed by a user.

According to yet another variant, the process of overlaying content is started in advance, for example during a batch process that is launched upon generation of the play list, or that is launched later whenever computing resources become available.

According to yet another variant embodiment of the invention, image frame sequences in which content has been overlayed, are stored in cache memory. The cache is implemented as RAM, hard disk drive, or any other type of storage, offered by one or more storage servers. Advantageously, this batch preparation is done upon generation of the play list.

Even if the generation of a targeted image frame sequence is programmed in a batch, there might not remain enough time to wait for the batch end. Such a situation can occur when a user uses a trick mode such as fast forward, or the batch generation is evolving too slowly due to unavailability of requested resources. In such a case, and according to a variant embodiment of the invention, the requested targeted image frame sequence is generated ‘on the fly’ (and is removed from the batch).

According to a variant embodiment of the invention that relates to the previously discussed batch process, a delay is determined that is available for preparing of the targeted image frame sequence. For example, considering the rendering point of a requested video, there might be enough time to overlay content in image frames using low cost, less powerful computing resources, whereas, if the rendering point approaches the targetable image frames, more costly computing resources with better availability and higher performance are required to ensure that content is overlayed in time. Doing so advantageously reduces computing costs. The determination of the delay is done using information on the consumption times of a requested video and the video bit rate. For example, if a user requests a video and requests a first image frame sequence at T0, it can be calculated using a known bit rate of the video that at T0+n another image frame sequence will probably be requested (under the hypothesis that the video is consumed linearly, i.e. without using trick modes, and that the video bit rate is constant).

As mentioned previously, a targeted image frame sequence can be stored on a storage server (for example, in a cache memory) to serve other users because it might happen that that a same targeted image frame sequence would convene to other users (for example, multiple users might be targeted the same way because they are interested in announcements of a same cinema in a same neighborhood). The decision to store or not to store can be taken by analyzing user profiles for example and searching for common interests. For example, if many users are interested in cars of a part make, it might be advantageous in terms of resource management to take a decision to store.

According to a variant embodiment of the invention, when the player requests a targeted image frame sequence which does not already exists in cache and there is not enough left for on the fly generation, or the on the fly generation fails for any reason (network problem, device failure, . . . ) a fall back solution is taken in which a default version of the image frame sequence is provided instead of a targeted image frame sequence. Such a default version is for example a version with a default advertisement or without any advertisement.

According to a variant embodiment of the present invention, the user device that requests a video has enough computational resources to do the online overlay operation itself. In this case, the overlayable content (such as advertisements) that can be chosen from, are for example stored on the user device, or, according to a variant embodiment, stored on another device, for example a dedicated advertisement server.

Advantageously, a “redirection” server is used to redirect a request for a specific targetable image frame sequence to a storage server or cache if it is determined that a targetable image frame sequence has already been prepared that convenes to a user that issues the request.

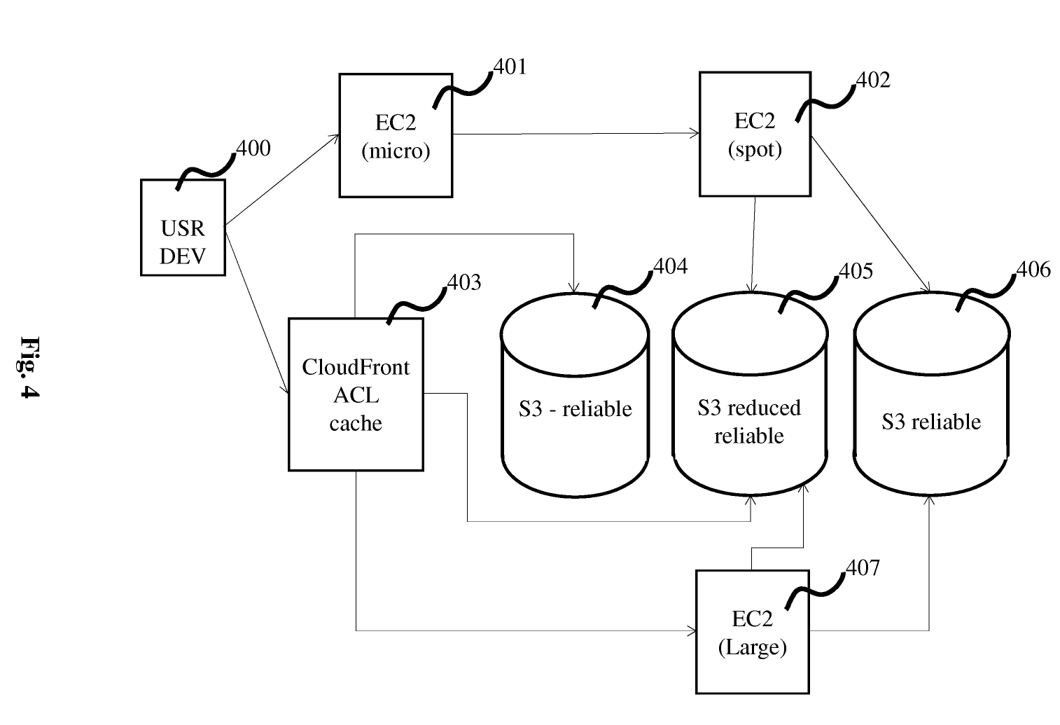

According to a variant embodiment, the method of the invention is implemented by cloud computing means, see FIG. 4 and its explanation.

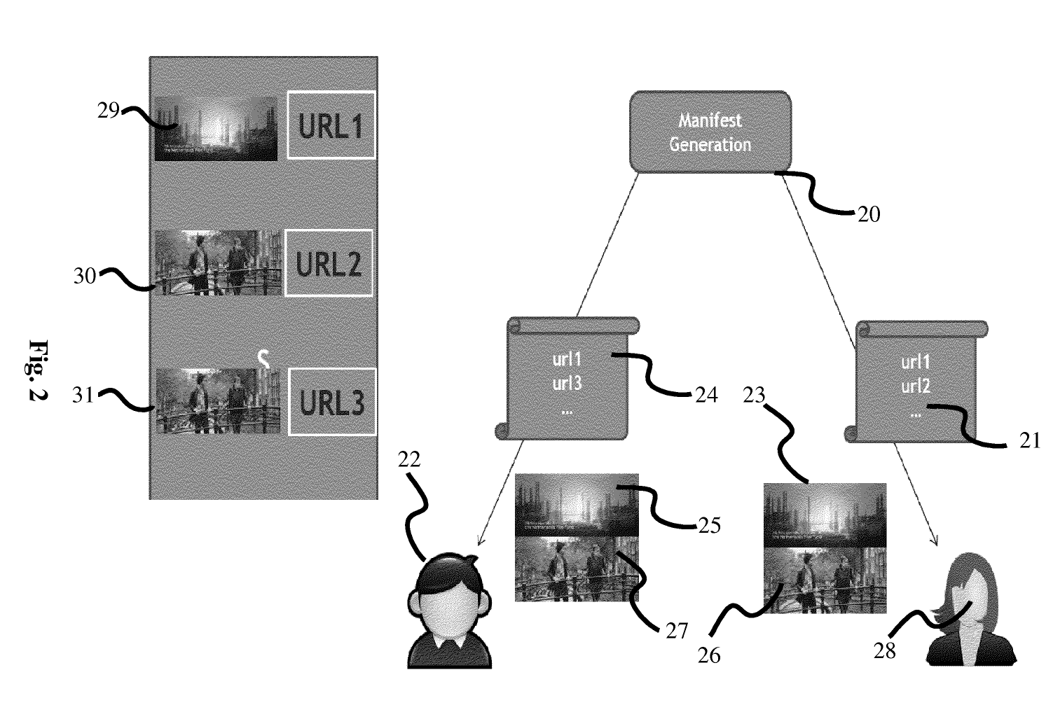

FIG. 2 illustrates some aspects of the method of providing of targetable content in image frames of a video according to the invention. According to the scenario used for this figure, there are two users, a user 22 and a user 28. Each receives images frame sequences of a video targeted to them. URL1 points to generic image frame sequence 29 that is the same for all users. URL3 points to a targeted image frame sequence (a publicity is overlayed in the bridge railing). URL2 points to a same targetable image frame sequence as URL3 where no overlayable content is overlayed. User 22 receives a manifest 24 that comprises URL1 and URL3. User 28 receives a manifest 21 that comprises URL1 and URL2. URL3 points to a batch prepared targeted content that was stored in cache because of its likely use for multiple users as it comprises an advertisement of a well known brand of drink.

Advantageously, all URLs point to a redirection server that redirects, at the time of the request of that URL, either to a server able to compute the targeted image frame sequence, or to a cache server which can serve a stored targeted image frame sequence. The stored targeted image frame sequence having being either a batch prepared targeted content, or content prepared previously for another user and stored.

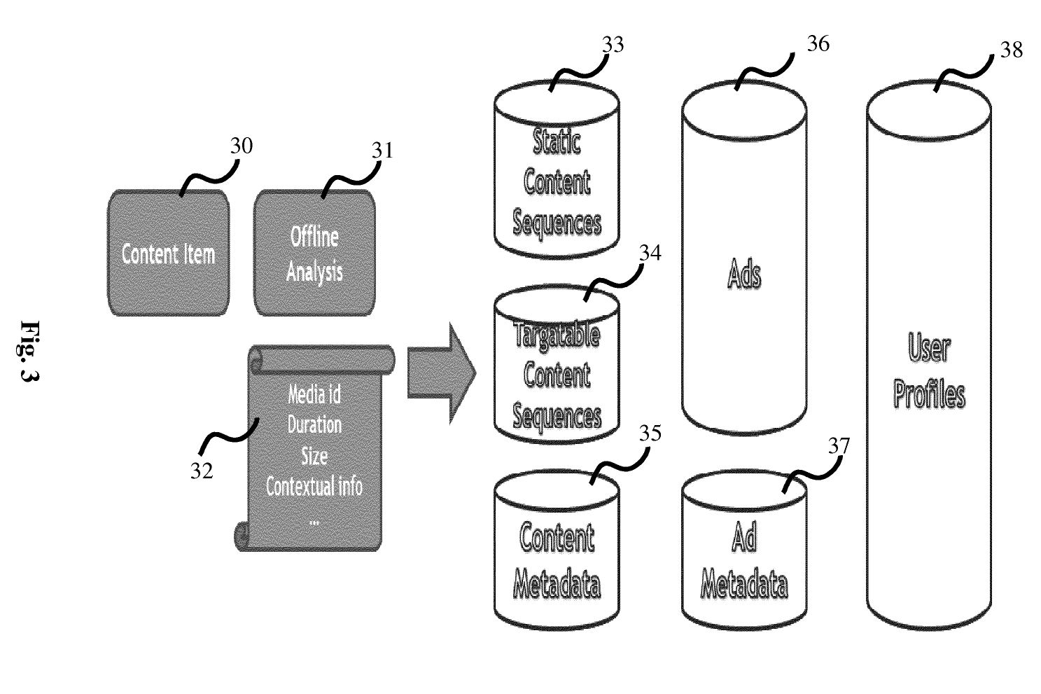

FIG. 3 shows an example of data that comes into play when providing targetable content in image frame sequences of a video according to the invention. A content item (30) i.e. a video is analyzed in a process (31). This results in creation of metadata (32). The analyze process results in the recognition in the video of generic image frame sequences (33) and of targetable image frame sequences (34). Information about the targetable image frame sequences is stored as metadata (35) that is associated to the video. Further data used is advertisements (36) and metadata (37) related to these advertisements as well as user profiles (38). The metadata related to the advertisements comprises information that can be used for an overlay operation, such as image size, form factor, level of allowed holomorphic transformation, textual description, etc. The user profiles and metadata (35, 37) are used to choose content for overlay for example one of the advertisements (36).

FIG. 4 depicts an architecture for a delivery platform according to a part embodiment of the invention using cloud computing. Cloud computing is more and more used for distribution of computing intensive tasks over a network of devices. It can leverage the method of the invention of providing targeted content in image frames of a video. Cloud computing services are proposed by several companies like Amazon, Microsoft or Google. In such a computing environment, computing services are rent, and tasks are dynamically allocated to devices so that resources match the computing needs. This allows flexible resource management. Typically, prices are established per second of computation and/or per byte transferred. According to the described particular embodiment of the invention, the flexible computing platform that is offered by cloud computing is used to offer targetable content in image frames of a video, through dynamic overlay of content at consumption (streaming) time. A video, a set of overlay content (such as advertisements) and a set of user profiles are available as input data. The video is analyzed (e.g. by offline preprocessing) and metadata is created as explained for FIG. 3. Now, appropriate overlay content is overlayed in targetable image frame sequences of the video when the video is transported to a user. Using a cloud computing platform allows then for the system to be fully scalable to demand growth. Such a cloud based method for providing targetable content in image frame sequences of a video may comprise the following steps:

(i) video processing for determining sequences of image frames in the video that comprise image zones for overlaying with targeted content (i.e. the largetable′ image frame sequences). During this step, metadata is created that is associated to the video that comprises the features that describe the determined the determined sequences of image frames and the image zones (the ‘overlay’ zones). Optionally and further during this step, the generic image frame sequences are (re-)encoded using a compact encoding format that is optimized for transport, whereas the targetable image frame sequences are (re-)encoded using a less compact encoding format that is however suited for editing, typically the previously discussed mezzanine format.

(ii) storing of the (re-)encoded image frame sequences (i.e. generic and targetable) in a cloud (e.g. Amazon S3). This cloud can be public or private.

(iii) storing of content destined for overlay in the cloud (private or public), together with associated metadata that describes the content and that can be used in a later phase for the content insertion.

(iv) maintaining a set of user profiles to be used for content targeting. These user profiles can be either stored in the public cloud or for privacy reasons, stored on a private cloud or on a user device.

(v) generation of a manifest upon request for a video, and transmission to the requester. The manifest file comprises links (e.g. URLs to image frame sequences of the video (i.e. targetable and generic image frame sequences).

(vi) transmission of the different image frame sequences listed in the manifest upon request, for example from a video player. Generic image frame sequences are provided from storage. Targeted image frame sequences are either provided from cache memory when suitable image frame sequences exists for the particular user for which the image frame sequence is destined, or are calculated ‘on the fly’, whereby previously preselected overlay content may be overlayed if such preselected overlay content exists.

Targeting a targetable image frame sequence comprises:
decoding the targetable image frame sequences;
overlaying a selected overlayable content in the targetable video image frame sequence, thereby obtaining a “targeted” image frame sequence;
encoding the targeted image frame sequence, preferably using an encoding format that is optimized for transport, and transmitting the targeted image frame sequence to the user device. To further optimize resource use needed for processing, if cache space is available, then storage in cache of the processed targetable image frame sequence can be stored in cache so that processing the targetable image frame sequence can be avoided when the image frame sequence is required for another user (for example, for users having similar user profiles). Likewise, references (links) to selected overlayable content can be stored, which can be retrieved later on as previously discussed.

FIG. 4 depicts an example cloud architecture used for implementation of a particular embodiment of the invention based on Amazon Web Services (AWS). For the current invention partly of interest are computing instances such as EC2 (Elastic Compute Cloud) for running of computational tasks (targeting, content overlay, user profile maintenance, manifest generation), storage instances such as S3 (Simple Storage Service) for storage of data such as generic image frame sequences and targetable image frame sequences, metadata, and CloudFront for data delivery. According to Amazon terminology, EC2 is a web service that provides sizeable computation capacity and offers a virtual computing environment for different kinds of operating systems and for different kinds of “instance” configurations. Typical instance configurations are “EC2 standard” or “EC2 micro”. The “EC2 micro” instance is well suited for lower throughput applications and web sites that require additional compute cycles periodically. There are different ways of getting resources in AWS. The first way, referred as “on demand” provides the guarantee that resources will be made available at a given price. The second mode, referred as “spot’ allows getting resources at a cheaper price but with no guarantee of availability. EC2 Spot instances allow obtaining a price for EC2 computing capacity by a bidding mechanism. These instances can significantly lower computing costs for time-flexible, interruption-tolerant tasks. Prices are often significantly less than on-demand prices for the same EC2 instance types. S3 provides a simple web services interface that can be used to store and retrieve any amount of data any time. Storage space price depends on the reliability that is wished, for example standard storage with high reliability and reduced redundancy storage for storing non-critical, reproducible data. CloudFront is a web service for content delivery and integrates with other AWS services to distribute content to end users with low latency and high data transfer speeds and can be used for streaming of content. In FIG. 4, element 400 depicts a user device, such as a Set Top Box, PC, tablet, or mobile phone. Reliable S3 404 is used for storing of generic image frame sequences and targetable image frame sequences. Reduced reliable S3 (405) is used for storing targeted image frame sequences that can easily be recomputed. Reduced reliable S3 (405) is used as a cache, in order to keep computed targeted image frame sequences for some time in memory. Reliable S3 406 is used for storing targetable image frame sequences in a mezzanine format, advertisements or overlay content, and metadata. EC2 spot instances 402 are used to pre-compute targeted image frame sequences. This computation by the EC2 spot instances, which can be referred to as ‘batch’ generation, is for example triggered upon the manifest generation. On-demand EC2 Large instances (407) is used to realize ‘on the fly’ or ‘real-time’ overlaying of content. Generation of a targeted image frame sequence is done as follows: a targetable image frame sequence is retrieved from S3 reliable (406), in mezzanine format, the targetable image frame sequence is decoded, an overlay content is chosen, overlayed in images of the targetable image frame sequence, and the targeted image frame sequence is re-encoded in a transport format. Depending on previously mentioned ‘on the fly’ or ‘batch’ computing of the targeted image frame sequence, the decoding of the targetable image frame sequences, choosing of overlay content, the overlaying and the re-encoding is either done in respectively an EC2 spot instance (402) or in an EC2 large instance (407). Of course, this described variant is only one of several strategies that are possible. Other strategies may comprise using different EC2 instances (micro, medium or large for example) for either one of ‘on the fly’ or ‘batch’ computing depending on different parameters such as delay, task size and computing instance costs, such that the use of these instances is optimized to offer a cost-effective solution with a good quality of service. The computed targeted image frame sequence is then stored in reduced reliable S3 (405) that is used as a cache in case of ‘batch’ computing, or directly served from EC2 large 407 and optionally stored in reduced reliable S3 405 in case of ‘on the fly’ computing. Batch computing of targeted image frame sequences is preferable for reasons of computing cost if time is available to do so. Therefore a good moment to start batch computing of targeted image frame sequences is when the manifest is generated. However if a user fast forwards to a targetable image frame sequence that has not been computed yet, more costly ‘on the fly’ computing is required. Now if a player on the device 400 requests image frame sequences, a previously discussed redirection server (not shown) verifies where the requested image frame sequence can be obtained, for example from reliable S3 (404) if the requested image frame sequence is a generic image frame sequence, from reduced reliable S3 if the requested frame sequence is a targetable image frame sequence that is already available in cache, from EC2 large (407) for ‘on the fly’ generation if the requested image frame sequence is a image frame sequence that is not available in cache. According to where the image frame sequence can be requested, the redirection server redirects the device 400 to the correct entity for obtaining it. Advantageously, the device 400 is not served directly from EC2/S3 but through a CDN/proxy such as CloudFront 403 that streams image frame sequences to the device 400. In short, targeted content can be provided from three sources with different URLs:
precomputed and available in reduced reliable S3 (405) that serves a as a cache area;
computed on the fly by EC2 Large (407);
as a fall-back solution, from reliable S3 (404) without content overlay (which is strictly speaking not ‘targeted’);
as another fallback solution, from reduced reliable S3 (405) with an overlayed content that does not strictly correspond to the user profile.

Thus, the player on device 400 requests a single URL, and is redirected to one of the sources discussed above.

The URLs in the manifest comprise all the information that is required for the system of FIG. 4 to obtain targeted content from each of these three sources in a way that is transparent to the user device that requests the URLs listed in the manifest.

While the above example is based on Amazon cloud computing architecture, the reader of this document will understand that the example above can be adapted to cloud computing architectures that are different from the above without departing from the described inventive concept.

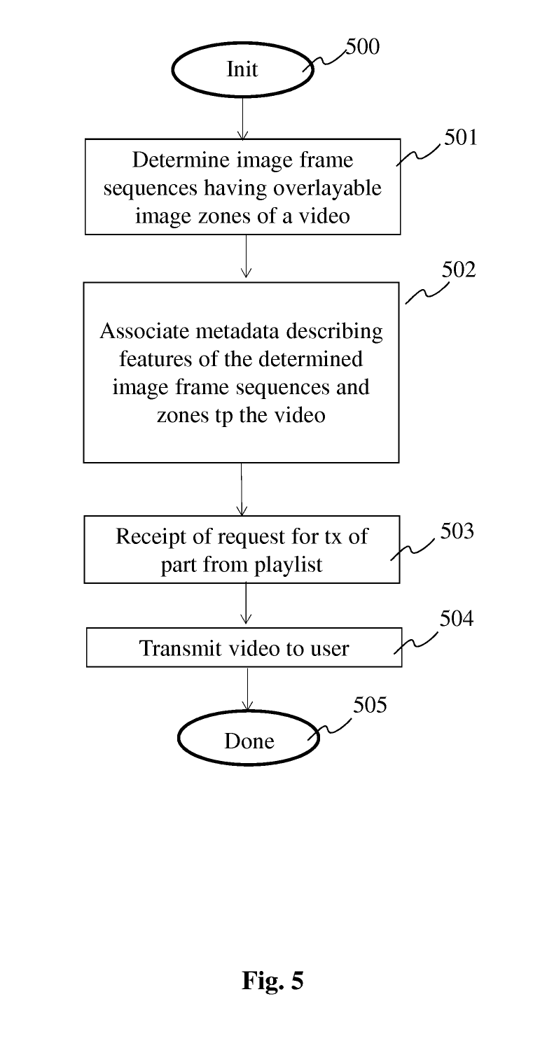

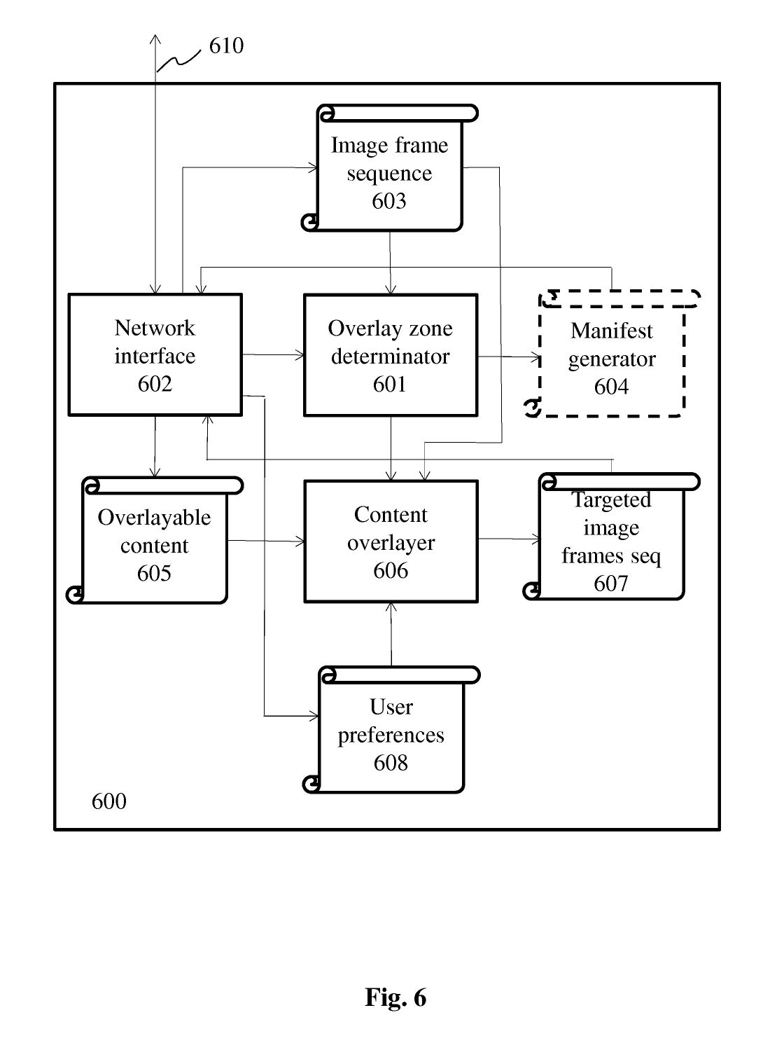

FIG. 5 illustrates a flow chart of a particular embodiment of the method of the invention. In a first initialization step 500, variables are initialized for the functioning of the method. When the method is implemented in a device such as server device 600 of FIG. 6, the step comprises for example copying of data from non-volatile memory to volatile memory and initialization of memory. In a step 501, sequences of image frames in said video that comprise image zones for overlaying with targeted content are determined. In a step 502, metadata is associated to the video. The metadata comprises features that describe the determined sequences of image frames and the image zones. In a step 503, a request for transmission of the video is received from a user. In a step 504, the metadata is used to overlay content in the image zones of sequences of image frames that are described by the metadata. The content is chosen or ‘targeted’ according to the metadata and according to user preference of the user. In a step 505, the video is transmitted to the user. The flow chart of FIG. 5 is for illustrative purposes and the method of the invention is not necessarily implemented as such. Other possibilities of implementation comprise the parallel execution of steps or batch execution.

FIG. 6 shows an example embodiment of a server device 600 for providing targeted content in image frames of a video.

The device comprises a determinator 601, a content overlayer 606, a network interface 602, and uses data such as image frame sequences 603, overlayable content 605, and user preferences 608, whereas it produces a manifest file 604 and targeted image frame sequences 607. The overlay content is stored locally or received via the network interface that is connected to a network via connection 610. The output is stored locally or transmitted immediately on the network, for example to a user device. Requests for video are received via the network interface. The manifest file generator is an optional component that is used in case of transmission of the video via a manifest file mechanism. The determinator 601 determines sequences of image frames in a video that comprise image zones for overlaying with targeted content, and associates metadata to the video. The metadata comprises the features that describe the sequences of image frames and the image zones determined by the determinator. The network interface receives user requests for transmission of a video. The content overlayer overlays in the video targeted content in the image zones of the image frame sequences that are referenced in the metadata that is associated to the video. The targeted content is targeted or chosen according to the associated metadata and according to user preference of the user requesting the video. The image frames of the video, i.e. the generic image frame sequences and the targeted image frame sequences, are transmitted via the network interface. If transmission of the video via a manifest file is used, the references to generic image frame sequences and targetable image frame sequences are provided to the manifest file generator that determines a list of image frame sequences of a requested video. This list comprises identifiers of the generic image frame sequences of the video that are destined to any user, and of the targetable image frame sequences that are destined for a particular user or group of user through content overlay. The identifiers are for example URLs. The list is transmitted to the user device that requests the video. The user device then fetches the image frame sequences referenced in the manifest file from the server when it needs them, for example during playback of the video.

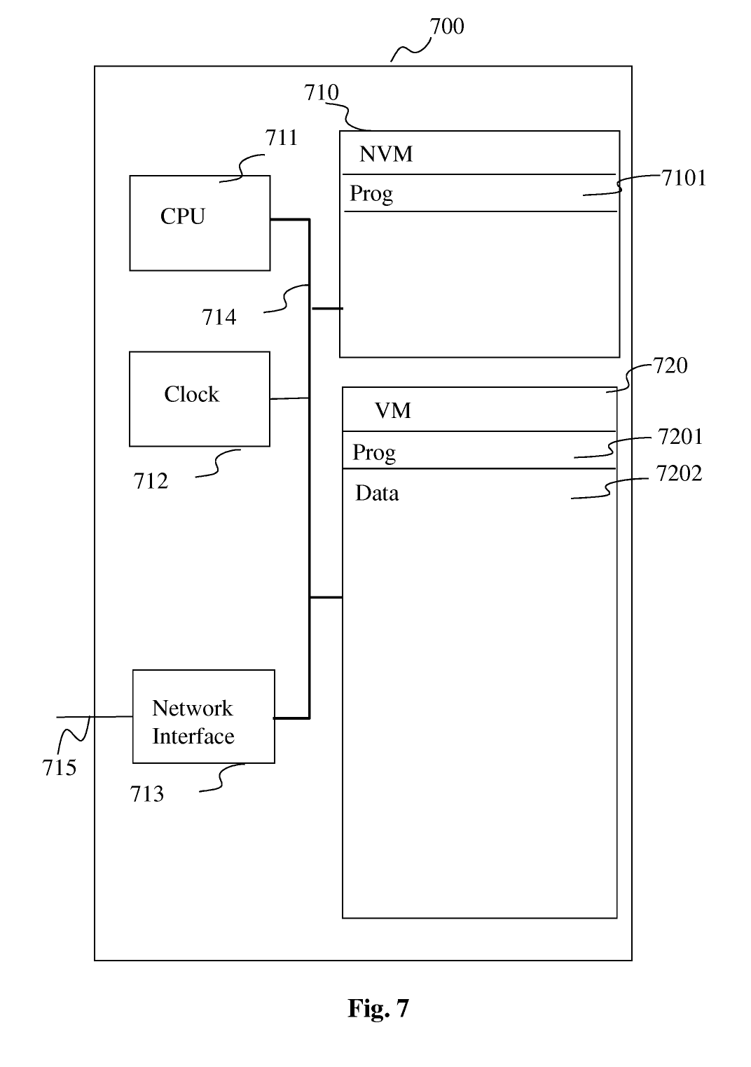

FIG. 7 shows an example embodiment of a receiver device implementing the method of the invention of receiving targetable content in images of a video sequence. The device 700 comprises the following components, interconnected by a digital data- and address bus 714:
a processing unit 711 (or CPU for Central Processing Unit);
a non-volatile memory NVM 710;
a volatile memory VM 720;
a clock unit 712, providing a reference clock signal for synchronization of operations between the components of the device 700 and for other timing purposes;
a network interface 713, for interconnection of device 700 to other devices connected in a network via connection 715.

It is noted that the word “register” used in the description of memories 710 and 720 designates in each of the mentioned memories, a low-capacity memory zone capable of storing some binary data, as well as a high-capacity memory zone, capable of storing an executable program, or a whole data set.

Processing unit 711 can be implemented as a microprocessor, a custom chip, a dedicated (micro-) controller, and so on. Non-volatile memory NVM 710 can be implemented in any form of non-volatile memory, such as a hard disk, non-volatile random-access memory, EPROM (Erasable Programmable ROM), and so on. The Non-volatile memory NVM 710 comprises notably a register 7201 that holds a program representing an executable program comprising the method according to the invention. When powered up, the processing unit 711 loads the instructions comprised in NVM register 7101, copies them to VM register 7201, and executes them.

The VM memory 720 comprises notably:
a register 7201 comprising a copy of the program ‘prog’ of NVM register 7101;
a register 7202 comprising read/write data that is used during the execution of the method of the invention, such as the user profile.

In this embodiment, the network interface 713 is used to implement the different transmitter and receiver functions of the receiver device.

According to a part embodiment of the server and the receiver devices according to the invention, these devices comprises dedicated hardware for implementing the different functions that are provided by the steps of the method. According a variant embodiment of the server and the receiver devices according to the invention, these devices are implemented using generic hardware such as a personal computer. According to yet another embodiment of the server and the receiver devices according to the invention, these devices are implemented through a mix of generic hardware and dedicated hardware. According to part embodiments, the server and the receiver device are implemented in software running on a generic hardware device, or implemented as a mix of soft- and hardware modules.

Other device architectures than illustrated by FIGS. 6 and 7 are possible and compatible with the method of the invention. Notably, according to variant embodiments, the invention is implemented as a mix of hardware and software, or as a pure hardware implementation, for example in the form of a dedicated component (for example in an ASIC, FPGA or VLSI, respectively meaning Application Specific Integrated Circuit, Field-Programmable Gate Array and Very Large Scale Integration), or in the form of multiple electronic components integrated in a device or in the form of a mix of hardware and software components, for example as a dedicated electronic card in a computer, each of the means implemented in hardware, software or a mix of these, in same or different soft- or hardware modules.

1-11. (canceled)

12. A method of providing targeted content in image frames of a video, the method being implemented in a server device, the method comprising:
receiving, from a user, a request for transmitting said video;
decoding image frame sequences in said video that are associated with metadata, said metadata comprising features describing the image frame sequences and overlay zones in image frames of said image frame sequences;
overlaying said overlay zones in image frames of said decoded image frame sequences with targeted content chosen according to said associated metadata and further according to user profile of said user;
re-encoding said decoded image frame sequences in which said overlay zones are overlaid with said targeted content; and
transmitting said video to said user.

13. The method according to claim 12, wherein said overlaying comprises adapting said targeted content to graphical features of said overlay zones in said image frame sequences.

14. The method according to claim 12, wherein said graphical features comprise a geometrical distortion of said overlay zones.

15. The method according to claim 12, wherein said graphical features comprise a luminosity of said overlay zones.

16. The method according to claim 12, wherein said graphical features comprise a colorimetric of said overlay zones.

17. The method according to claim 12, wherein said metadata features comprise a description of a scene to which said image frame sequences belong.

18. The method according to claim 12, further comprising re-encoding the video in a preprocessing step wherein image frame sequences in said video that are associated with metadata start with a Group of Pictures.

19. The method according to claim 12, further comprising re-encoding the video in a preprocessing step wherein image frame sequences in said video that are associated with metadata are re-encoded as a closed Group of Pictures.

20. The method according claim 2, further comprising re-encoding the video in a preprocessing step wherein image frame sequences in said video that are associated with metadata are re-encoded using a lower compression rate than other sequences of image frames in said video.

21. A server device for providing targeted content in image frames of a video, wherein the device comprises:
a network interface configured to receive a request from a user for transmission of said video;
a content overlayer, configured to decode image frame sequences in said video that are associated with metadata, said metadata comprising features describing image frame sequences and overlay zones in image frames of said image frame sequences;
said content overlayer being further configured to overlay image zones said decoded image frame sequences with targeted content chosen according to said associated metadata and further according to user profile of said user;
said content overlayer being further configured to re-encode said decoded image frame sequences in which said overlay zones are overlaid with said targeted content; and said network interface being further configured to transmit said video to said user.

22. The server device according to claim 21, wherein said content overlayer is further configured to adapt said targeted content to graphical features of said overlay zones in said image frame sequences.
